(19) United States
(12) Patent Application Publication
(10) Pub. No.: US 2009/0183207 A1
(43) Pub. Date: Jul. 16, 2009

(54) Integrated Content User Interface For A Portable Media Player

(76) Inventors: Neil Patel, Pasadena, CA (US); Gary Todd Masilko, South Pasadena, CA (US)

Correspondence Address: Michael J. Tempel;SMITH FROHWEIN TEMPEL, GREENLEE BLAHA LLC, TWO RAVINIA DRIVE, SUITE 700, Atlanta, GA, 30346, US

(21) Appl. No.: 11/971,957

(22) Filed: Jan. 10, 2008

(51) Int. Cl. G06F 3/00

(52) U.S. Cl. 725/58

(57) ABSTRACT

A system for integrating video content in a user interface includes a mobile broadcast receiver for receiving primary content and secondary content in a portable communication device, and a mobile service guide for simultaneously displaying the availability of the primary content and the secondary content.

### BACKGROUND

The use of portable handheld communications devices has proliferated throughout the world to the extent that that there are individuals that use such devices as their primary communication platform. Portable handheld communication devices are now available to receive and display mobile broadcast video content. A device having such capability can be referred to as portable media player and include, for example, a portable cellular-type telephone, a personal digital assistant (PDA), and devices that incorporate telephone and PDA functionality, and a dedicated portable media player. Streaming or downloadable content for a portable media player can be provided in a number of ways and using a number of different technologies. A non-limiting example of a standard that allows the delivery of video content to a portable communication device incorporating a portable media player is the digital video broadcast for handheld devices (DVB-H) communication standard. However, many other broadcast video delivery protocols, such as, for example only, digital media broadcast (DMB), advanced vestigal sideband (AVSB), mobile pedestrian handheld, Media Flo™, and others. AVSB is a standard that allows multiple streams of video to be broadcast within the advanced televisions systems committee (ATSC) digital television broadcast signal. For example, this could include a “mobile” channel alongside the standard or high definition version of the same channel.

In addition, there are non-broadcast technologies for delivering content to a portable communication device incorporating a portable media player. Examples of non-broadcast technologies include, for example, Wi-Fi according to IEEE 802.11 and all variations, WiMAX according to IEEE 802.16 and all variations and Internet Protocol (IP) standards.

Typically, content provided to a communication device incorporating a portable media player will be displayed on some form of channel guide that is shown to a user on the device's display. The user can scroll through the available broadcast content using the device's user interface to identify the content that the user wishes to view. A challenge when delivering non-broadcast content is that the non-broadcast content is typically not integrated into the device's channel guide. A similar situation exists when any additional content is provided to a portable communication device through, for example, an external memory card associated with the portable communication device.

Therefore, it would be desirable to have a user interface that incorporates and lists all available content.

### SUMMARY

In an embodiment, a system for integrating video content in a user interface comprises a mobile broadcast receiver for receiving primary content and secondary content in a portable communication device, and a mobile service guide for simultaneously displaying the availability of the primary content and the secondary content.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures.

The components within the figures are not necessarily to scale, emphasis instead being placed upon clearly illustrating the principles of the invention. Moreover, in the figures, like reference numerals designate corresponding parts throughout the different views.

FIG. 1 is a schematic diagram illustrating an additional content system in accordance with an embodiment of the system and method for providing additional content to a program stream.

FIG. 2 is a block diagram illustrating a simplified portable communication device in accordance with an embodiment of the integrated content user interface.

FIG. 3A is a schematic diagram illustrating an example of a mobile service guide.

FIG. 3B is a schematic diagram illustrating a mobile service guide shown on a portable communication device that has entered an area in which secondary content is available.

FIG. 4 is a schematic diagram illustrating a mobile service guide according to an alternative embodiment of the integrated content user interface.

FIG. 5 is a flow chart describing the operation of an embodiment of the system and method for providing additional content to a program stream.

### DETAILED DESCRIPTION

The integrated content user interface will be described in the context of integrating a secondary content into a user interface and display along with a primary content. However, the integrated content user interface can be used to associate any secondary content with primary content. The integrated content user interface includes a system and method of listing all available media content into a single, easy to browse user interface located on a portable communication device, which may also be referred to as a media device, or a portable media device. The content is browsable in a single menu structure, regardless of the delivery method or storage location of the media on the portable media device. The integrated content user interface works with streaming and cached media that has been created and delivered using a variety of formats and practices.

The integrated content user interface can be implemented in hardware, software, or a combination of hardware and software. When implemented in hardware, the integrated content user interface can be implemented using specialized hardware elements and logic. When the integrated content user interface is implemented in software, the software can be used to control the various components in a system and network associated with the program. The software can be stored in a memory and executed by a suitable instruction execution system (microprocessor). The hardware implementation of the integrated content user interface can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the integrated content user interface comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

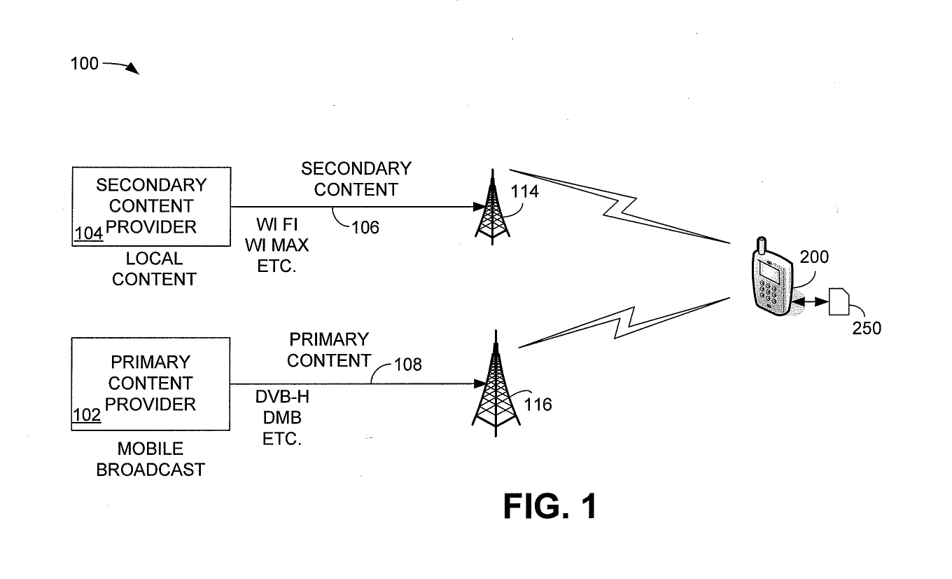

FIG. 1 is a schematic diagram illustrating a system 100 in which a portable communication device incorporating the integrated content user interface can be implemented. The system 100 includes a primary content provider 102. The primary content provider 102 can be, for example, a mobile broadcast provider that provides mobile broadcast video programming. The mobile broadcast video programming can be streaming or downloadable content for a portable media player. The primary content provider 102 can provide a mobile broadcast according to a number of different standards, some of which include, for example, digital video broadcast for handheld devices (DVB-H), digital media broadcast (DMB), Media Flo™, etc. The primary content provider 102 can provide content via other standards as well.

The primary content is provided to a distribution network 116. The distribution network can be, for example, a mobile communications carrier, a network service provider, or any entity that can distribute a mobile broadcast. In an embodiment, the primary content provider 102 and the distribution network 116 may be operated by the same entity. In an alternative embodiment, the primary content provider 102 and the distribution network 116 are separate entities that collaborate to provide the content to a user.

A portable communication device 200 is capable of being in wireless contact with the distribution network 116. In an embodiment, the portable communication device 200 can be a cellular-type telephone having the capability to receive and play a mobile video content, and can also be referred to as a portable media player.

However, the portable communication device 200 can be any device that can receive and play mobile video content. For example, the portable communication device 200 can be a personal digital assistant (PDA), a dedicated portable media player, or any other device that can receive and play video content.

In an embodiment, the portable communication device 200 includes or can accept a media card 250. The media card 250 can be, for example, a memory card such as an SD memory card, an MMC memory card, or any flash memory, or storage device. In an embodiment, the media card 250 contains the video programming that will be played on the portable communication device 200. The video programming can be either prerecorded onto the media card 250, or can be saved to the media card 250 after or while being received by the portable communication device 200. In an embodiment, video programming is prerecorded onto the media card 250 leaving sufficient memory space to add additional programming using the portable communication device 200.

The system 100 also includes a secondary content provider 104. The terminology “secondary” refers to content in addition to the content provided by the primary content provider 102 and does not relate to the importance of the content.

The secondary content provider 104 can be, for example, a local entity that provides localized content via, for example, a WiFi network employing the IEEE 802.11 standard or variations thereof, a WiMAX network employing the IEEE 802.16 standard or variations thereof, a network employing Internet Protocol (IP), or similar network. As a non-limiting example, the secondary content provider 104 can be an establishment that provides local video content. For example, the secondary content provider 104 can be a theme park that provides local programming within its geographical area. Other examples include shopping malls, trade show venues, concert halls and stadiums, movie theaters, retail stores, or any other entity that may provide local content.

In an alternative embodiment, constantly updated “feeds” of almost any type of content posted online, including video, podcasts, or images can be provided to a portable communication device. The term RSS, which is sometimes referred to as “really simple syndication” or “rich site summary,” is a format for delivering updated and rapidly changing content via the world wide web. Using a podcast as an example, the integrated content user interface can display the availability of primary content, a list of recorded content as secondary content and a daily updated podcast as additional secondary content.

In an embodiment, the secondary content provider 104 associates meta data with the secondary content so that the secondary content can be displayed to a user on a channel guide along with the primary content. The insertion of meta data in the secondary content is known to those skilled in the art.

The secondary content is provided to a distribution network 114. The distribution network 114 can be, for example, a local network provided by the secondary content provider. In an alternative embodiment, the secondary content provider 104 and the distribution network 114 are separate entities that collaborate to provide the secondary content to a user.

In an embodiment, when the portable communication device 200 enters a location in which the distribution network 114 provides secondary content, the secondary content is made available on the portable communication device 200 along with the primary content. Both the primary content and the secondary content are incorporated into the user interface and the channel or content guide presented to a user on the portable communication device 200.

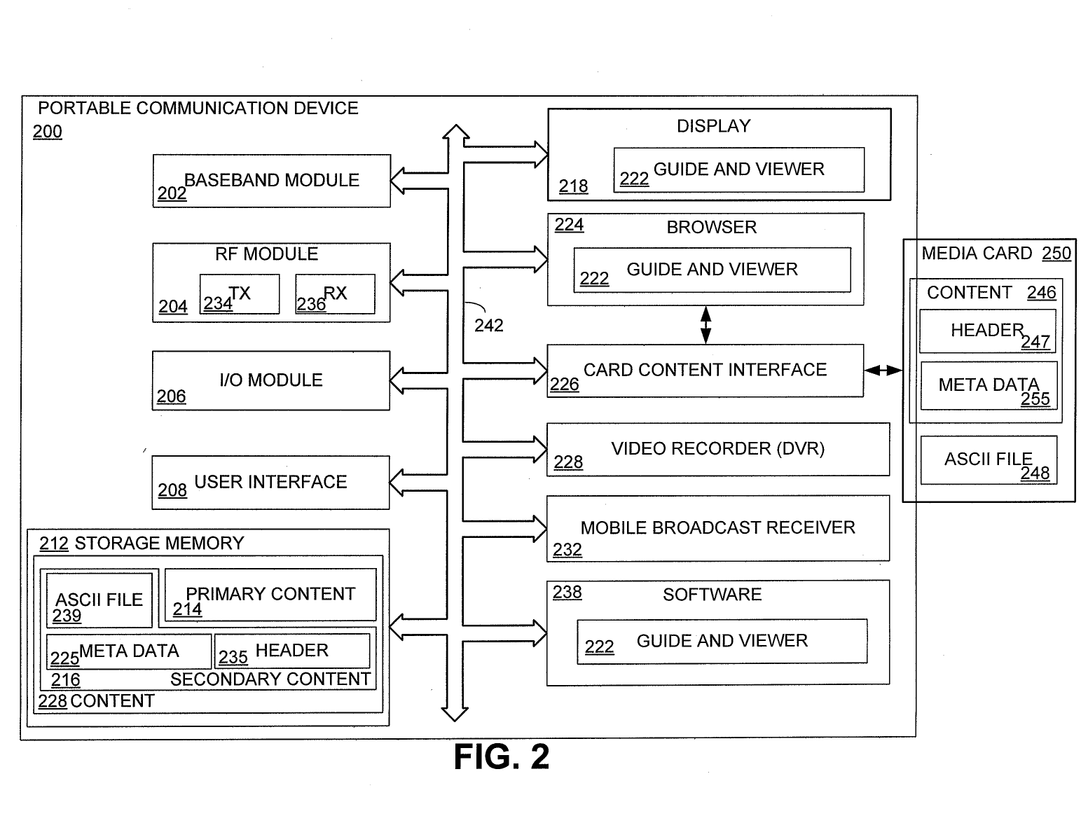

FIG. 2 is a block diagram illustrating a simplified portable communication device in accordance with an embodiment of the integrated content user interface. Only the basic elements of a portable communication device will be illustrated as the operation of such devices is understood by those skilled in the art. The portable communication device 200 includes a baseband module 202, a radio frequency (RF) module 204, an input output (I/O) module 206, a user interface 208, a storage memory 212, a display 218, a browser 224, a card content interface 226, an optional media recorder 228, which may be a digital video recorder (DVR), a mobile broadcast receiver 232 and software 238 connected via a logical and physical communication bus 242.

The RF module 204 generally contains a transmitter 234 and a receiver 236, as known in the art. The baseband module 202 and the RF module 204 also contain analog, digital and mixed signal circuitry and software that allow the portable communication device 200 to transmit and receive voice and data signals, and will not be described in detail as they would be understood by one having ordinary skill in the art. The I/O module 206 includes the interfaces that allow the portable communication device 202 to send, receive and interpret information. Depending on the type of portable communication device, the user interface 208 may include one or more of the following: a microphone, a speaker, a keyboard, a touchpad, a mouse, a trackball, a pointing device, and any other user input and output devices. The storage memory 212 includes the memory used for the normal operation of the portable communication device 200 and also includes a location at which to store the primary content 214 and a location at which to store secondary content 216. The secondary content 216 represents any additional content that is delivered to the portable communication device 200 in accordance with the embodiments described herein. In an embodiment, the secondary content 216 includes header information 235 and meta data 225. The meta data 225 is associated with the secondary content 216 to allow the portable communication device 200 to display the secondary content 216 along with primary content 214 on the display 218. In an embodiment, the storage memory 212 also includes an American Standard Code for Information Exchange (ASCII) file 239, or other means, which can be created and used by the browser 224 and the guide and viewer software 222 to display the secondary content 216. In alternative embodiments, the secondary content 216 may not include header information 235. The provision of header information 235 in the secondary content 216 is illustrated as one possible implementation.

In an embodiment, the primary content 214 and the secondary content 216 can be logically linked together. For example, the secondary content 216 may be linked to the primary content 214 based on genre, content type, a search query or search criteria entered by a user, etc. Further, the secondary content can be associated with video and/or audio programming, and/or advertisements.

For example, a mobile advertisement may include secondary content in the form of an electronic coupon and store locator. If the primary content is sports programming, for example, while watching a live game on a network, the secondary content could be any number of things, such as a live ticker with personalized fantasy sports content (scores, alerts), an alert icon showing activity within a fantasy league. A dynamic link to a mobile message client linked to fantasy league team members, etc.

In another non-limiting example, mobile programming can be triggered by location. For example, a mobile device owner takes their phone/media player 200 to a concert and downloads a free concert track, where the free concert track is the secondary programming and is related to the artist. Meta data embedded in the download records the fact that the user was at the live show and triggers bonus content associated with the concert. For example, free wallpapers, ringtones, etc., can be downloaded and stored in the appropriate location on the users phone/media player 200.

In another example, advertising can be placed within a “mobile video channel.” Meta data can be used to maintain a log of which mobile advertisements a viewer has already seen, and generate a “playlist” that draws from a wide variety of advertisements over the course of repeated viewings of episodes of a program. An ASCI viewing log can be created that associates to a database of “Secondary Ad Content” and generates a playlist, which could be a way to create a “TV like” personalized mobile ad viewing experience.

The portable communication device 200 also includes a software element 238.

The software element 238 includes guide and viewer software 222. The guide and viewer software 222 includes the software that the portable communication device 200 uses to display a program guide and viewing options to a user of the portable communication device 200. In this embodiment, the guide and viewer software 222 interacts with the I/O module 206 and the display 218. The guide and viewer software 222 includes logic for integrating the secondary content 216 and the primary content 216 into the display 218 so that the user can view the available content, whether primary or secondary, in an integrated display.

The portable communication device 200 also includes a browser 224, which includes an instance of the guide and viewer software 222. The browser 224 enables a user to scroll through the available content.

A media card 250 can be removably installed in the portable communication device 200. The media card can be any removable memory device, such as an SD card, an MMC card, or any flash memory, or similar storage device. The media card 250 includes content 246. The content 246 can include primary content, secondary content, or a combination of primary and secondary content. The content 246 may include header information 247 and meta data 255. The meta data 255 is associated with the content 246 to allow the portable communication device 200 to display the content 246 on the media card 250 along with primary content 214 on the display 218. The media card 250 could include an ASCII file 248, or other means, which can be created and used by the browser 224 and the guide and viewer software 222 to display the content 246. The portable communication device 200 includes a card content interface 226, which connects the media card 250 to the logical and physical communication bus 242.

The portable communication device 200 also includes a mobile broadcast receiver 232 and a media recorder 228. In an embodiment, the mobile broadcast receiver 232 receives primary content 214 and secondary content 216. In an embodiment, the media recorder 228 can be used to record the primary content 214 and the secondary content 216 and store the content in the storage memory 212. In another embodiment, the primary content and the secondary content are not stored, but made available to a user on the display 218.

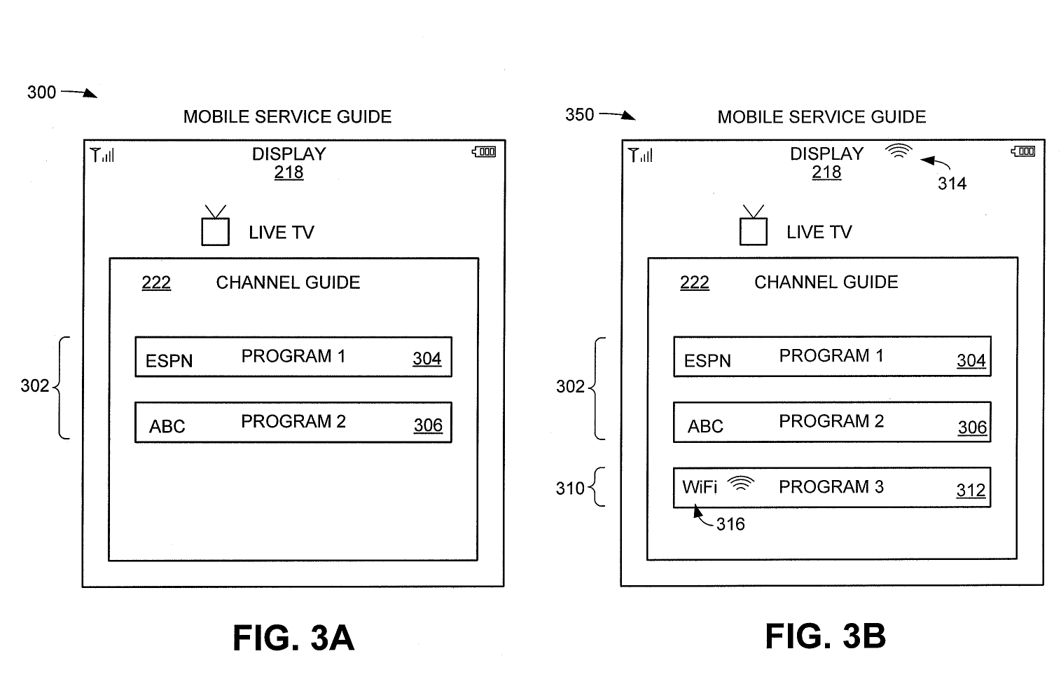

FIG. 3A is a schematic diagram illustrating an example of a mobile service guide 300. The mobile service guide 300 includes the display 218 includes a visual representation of the channel guide 222. In this example, two live television broadcasts 302 are being received by the portable communication device 200, the availability of which is shown in the channel guide 222. In this example, the two live television broadcasts 302 are referred to as primary content. The two live television broadcasts are illustrated as first program 304 and second program 306.

FIG. 3B is a schematic diagram illustrating a mobile service guide 350 shown on a portable communication device 200 that has entered an area in which secondary content is available. In this example, the secondary content is illustrated using reference numeral 310 and can be provided by a local wireless network, such as a WiFi network. However, other ways of providing secondary content are available. When the portable communication device 200 enters an area in which such secondary content is available, an alert icon 314 is shown in the display 218. The alert icon 314 signifies the availability of secondary content 3 10. Further, the design and appearance of the alert icon can be specific to the type of secondary content that is available.

In this example, the availability of the secondary content is shown in the channel guide 222 as third program 312. In accordance with this embodiment, the secondary content shown as third program 312 is integrated with and is shown as part of the channel guide 222 along with the two live television broadcasts 302. In this example, the “WiFi” nomenclature 316 is shown in the channel guide 222 as a source-specific icon to signify to a viewer that the program three 312 is being provided by a network different than the network over which the two live television broadcasts 302 are provided. The icon 316 communicates to a user that this particular program is unique to the local area in which the portable communication device 200 is presently located. Other source specific icons may be shown, depending on the source of the secondary content 216.

In an embodiment, and because WiFi uses the Internet Protocol (IP) to deliver content, the guide and viewer software 222 (FIG. 2) analyzes the IP data stream of the secondary content 216. The IP data stream of the secondary content 216 (FIG. 2) includes meta data 225 (FIG. 2) that is compatible with or understandable by the guide and viewer software 222 that is used to provide the mobile broadcast service guide 350. In order to work with the widest possible range of content, the primary content 214 is assumed to have been created in a way consistent with industry standards. For example, if the primary content 214 is broadcast, an example of a standard is DVB-H broadcast among many others. If the primary content 214 is cached, or otherwise saved, and desired to be protected, an example of an encoding standard is digital rights management (DRM) open mobile alliance, sometimes referred to as open media alliance (OMA), Windows DRM, etc. OMA is an “open source” DRM standard supported by companies including wireless operators and device manufacturers. It is well known in the media industry as an alternative to proprietary DRM standards.

An industry standard for meta data is, for example, an ID3, or an ID4 meta data tag, etc. In an embodiment, using industry standard encoding for content and meta data provides that the guide and viewer software 222 should to be able to read any/all industry standard meta data formats. The secondary content 216 that will be associated or linked with the primary content 214 should have meta data 225 compatible with the integrated content user interface. In an embodiment, the meta data 225 is included in the primary content 214 and the secondary content 216 so that the data structure of the content and the meta data can be deciphered by the portable communication device 200 and incorporated into the user interface. The guide and viewer software 222 scans the secondary content 216 for a unique identifier. The unique identifier may include, for example, a filename extension, media file header information 235, meta data 225, a file name or other information. If the guide and viewer software 222 detects a unique identifier, which in this example is the meta data 225, then the secondary content 216 is displayed along with the primary content 214. In an embodiment, the guide and viewer software 222 writes the file name, header information and meta data into an ASCII file 239. The ASCII file 239 contain a list of files, names, dates and meta data to be used by the guide and viewer software 222 to display the secondary content 216 on the display 218. This enables wireless IP-delivered content to be detected and displayed in a channel guide 222 along with the traditional broadcast content.

An ASCII file created by the guide and viewer software 222 would be a likely implementation for locally stored files. In another embodiment, in which an electronic program guide is provided to the portable communication device, the guide and viewer software 222 would receive and read a file provided by the broadcast service. For example, cable boxes receive a file with program listings and times from a service provider. In this example, and to display such a program guide, the guide and viewer software 222 would decipher the content.

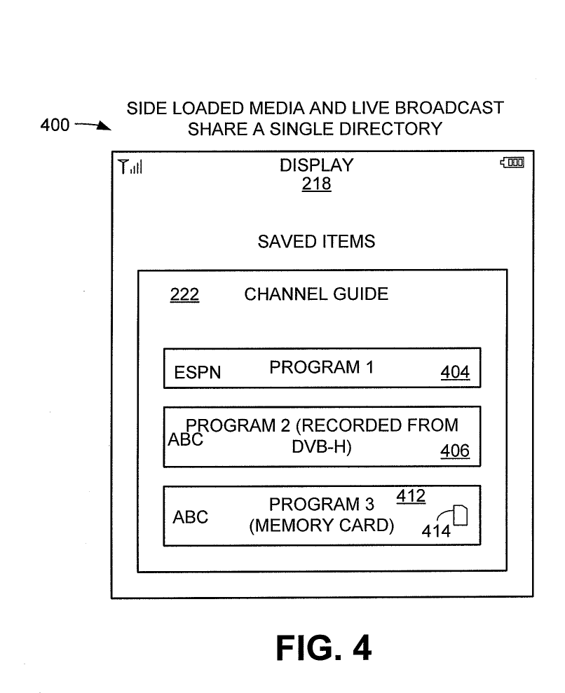

FIG. 4 is a schematic diagram illustrating a mobile service guide 400 according to an alternative embodiment of the integrated content user interface. The display 218 includes a channel guide 222 that, in this example, is displaying the availability of items that are saved on the portable communication device 200.

In this example, a first program 404 is received by the mobile broadcast receiver 232 (FIG. 2) and viewed and/or saved as primary content 214 in the storage memory 212. The second program 406 is illustrated, in this example, as having been recorded live using the optional media recorder 228 and stored as primary content 214 in the storage memory 212. The first program 404 and the second program 406 are displayed to a user using the channel guide 222.

In accordance with this embodiment, content 246 that is provided to the portable communication device 200 on the media card 250 (FIG. 2) can also be stored and/or viewed on the portable communication device 200 as secondary content 216, or can remain on the media card 250, and shown to a user as program three 412 in the channel guide 222. In this example, the icon 414 is a source-specific icon that communicates to the user that the program 412 is content that originated from, or is still stored on, the media card 250. In this manner, a single channel guide 222 can incorporate and display to a user the availability of programming from multiple sources. In this example, the content 246 provided on the media card 250 uses meta data 255 that is also compatible with or understandable by the channel guide 222. The content 246 on the media card 250 is automatically indexed with the live broadcast (the first program 404) and with recorded content (the second program 406). The secondary content from the media card 250 can be searched based on a variety of criteria. For example, the media card can be searched based on genre, title, date, file size, format, media property, etc. In an embodiment, the content 246 on the media card 250 can be automatically indexed with the live broadcast (the first program 404), with recorded content (the second program 406), and with secondary content 216, illustrated as third program 312 in FIG. 3B.

The guide and viewer software 222 scans the content 246 for a filename extension, media file header information 247, meta data 255 and a file name. If the guide and viewer software 222 detects the meta data 255, then the content 246 is displayed along with the primary content 214. The guide and viewer software 222 writes the file name, header information and meta data into an ASCII file 248 that can be located on the media card 250 or on the storage memory 212. The ASCII file 248 contains a list of files, names, dates and meta data to be used by the guide and viewer software 222 to display the content 246 on the display 218.

In another embodiment, the media card 250 can include pre-recorded content 246 but can also include additional memory space so that other content on the portable communication device 200 can be transferred to and saved on the media card 250.

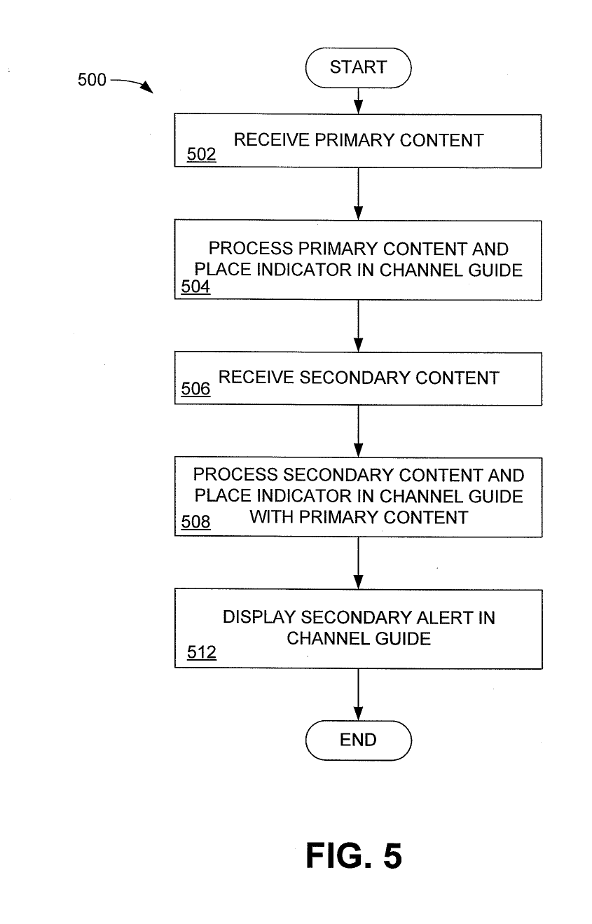

FIG. 5 is a flow chart describing the operation of an embodiment of the system and method for providing additional content to a program stream. The blocks in the flow chart shown in FIG. 5 can be performed in or out of the order shown by the elements described above, or can be performed by different elements. In block 502, primary content is received by the portable communication device 200. In block 504, the primary content is processed by the portable communication device 200 and an indicator of the availability of the primary content is placed in the channel guide 222 (the first program 304 in FIG. 3B). In block 506, secondary content is received by the portable communication device 200. In block 508, the portable communication device 200 processes the secondary content and places an indicator in the channel guide 222 indicating the availability of the secondary content along with the availability of the primary content. In block 512, an alert icon (314 of FIG. 3B, or 414 of FIG. 4) is displayed to a user in the channel guide 222 indicating the source of the secondary content.

While various embodiments have been described, it will be apparent to those of ordinary skill in the art that many more embodiments and implementations are possible that are within the scope of the invention. The integrated content user interface is not limited to a specific type of content or to a specific type of content delivery.

What is claimed is:

1. A system for integrating video content in a user interface, comprising:
a mobile broadcast receiver for receiving primary content and secondary content in a portable communication device; and
a mobile service guide for simultaneously displaying the availability of the primary content and the secondary content.

2. The system of claim 1, in which the primary content is a mobile video broadcast and the secondary content is a local broadcast.

3. The system of claim 1, in which the primary content is a mobile video broadcast and the secondary content is provided by a memory card.

4. The system of claim 2, further comprising an alert icon indicating the availability of the secondary content.

5. The system of claim 1, in which the primary content is delivered by a system chosen from digital video broadcast for handheld devices (DVB-H), digital media broadcast (DMB) AND Media Flo™.

6. The system of claim 1, in which the secondary content is delivered by a system chosen from WiFi, WiMAX and Internet Protocol (IP) and is dynamically updated.

7. The system of claim 1, in which the secondary content is identified in the mobile service guide using a source-specific icon.

8. The system of claim 1, further comprising meta data in the secondary content to identify the secondary content to the mobile service guide.

9. A method for integrating video content in a user interface, comprising:
receiving primary content in a portable communication device;
displaying availability of the primary content in a user interface;
receiving secondary content in a portable communication device; and
simultaneously displaying availability of the secondary content and the primary content in an integrated mobile service guide.

10. The method of claim 9, in which the primary content is a mobile video broadcast and the secondary content is a local broadcast.

11. The method of claim 9, in which the primary content is a mobile video broadcast and the secondary content is provided by a memory card.

12. The method of claim 10, further comprising displaying an alert icon indicating the availability of the secondary content.

13. The method of claim 12, further comprising delivering the primary content by a system chosen from digital video broadcast for handheld devices (DVB-H), digital media broadcast (DMB) and Media Flo™.

14. The method of claim 13, further comprising delivering the secondary content by a system chosen from WiFi, WiMAX and Internet Protocol (IP) and is dynamically updated.

15. The method of claim 14, further comprising identifying the secondary content using a source-specific icon.

16. A portable communication device having an integrated content user interface, comprising:
a receiver;
a mobile broadcast receiver for receiving primary content and secondary content in a portable communication device; and
a mobile service guide for simultaneously displaying the availability of the primary content and the secondary content.

17. The portable communication device of claim 16, further comprising an transmitter and in which the primary content is a mobile video broadcast and the secondary content is a local broadcast.

18. The portable communication device of claim 16, in which the primary content is a mobile video broadcast and the secondary content is provided by a memory card.

19. The portable communication device of claim 16, further comprising an alert icon indicating the availability of the secondary content.

20. The portable communication device of claim 16, in which the primary content is delivered by a system chosen from digital video broadcast for handheld devices (DVB-H), digital media broadcast (DMB) and Media Flo™ and the secondary content is delivered by a system chosen from WiFi, WiMAX and Internet Protocol (IP), and in which the secondary content is dynamically updated and is identified in the mobile service guide using a source-specific icon.

21. A content guide for integrating video content in a user interface, comprising:
a receiver for receiving primary content and secondary content, wherein the content guide simultaneously displays the availability of the primary content and the secondary content.
